(19) United States
(12) Patent Application Publication
(10) Pub. No.: US 2002/0001262 A1
(43) Pub. Date: Jan. 3, 2002

(54) Optical disk device and method capable of adjusting a tilt of an object lens

(76) Inventors: Naotoshi Iwazawa, Tokyo (JP); Yasushi Toda, Tokyo (JP)

Correspondence Address: McGinn & Gibb, PLLC, Suite 200, 8321 Old Courthouse Road, Vienna, VA, 22182-3817, US

(21) Appl. No.: 09/892,498

(22) Filed: Jun. 28, 2001

(30) Foreign Application Priority Data
Jun. 29, 2000 (JP) 195938/2000

(51) Int. Cl. G11B 7/095

(52) U.S. Cl. 369/44.36; 369/53.19

(57) ABSTRACT

A tile actuator of an object lens in an optical disk device is controlled by a tilt controller that includes a filter for stopping a signal with first resonance frequency of the tilt actuator, a filter for amplifying a signal with a frequency less than the rotational frequency of the disk, and a filter for restricting current for driving the tilt actuator.

### BACKGROUND OF THE INVENTION

This invention relates to an optical disk device having an object lens and, in particular, to an optical disk device that can adjust a tilt angle of the object lens.

Generally, in an optical disk device, a tilt inescapably takes place between a disk or medium and an object lens included in the optical disk device. Such an increase of the tilt gives rise to degradation of a signal output from the optical disk device. The aggravation more seriously affects recording/reproducing by the optical disk device when recording density of the medium becomes higher. Recently, recording density of the disk, namely, an optical recording medium tends to be higher from year to year. Therefore, the tilt should be restricted so as to improve a signal quality. It may be an available approach to reduce amount of the tilt, or to cancel alteration of signal. Hereinafter, description will be made about reducing amount of the tilt.

(1) First Conventional Technique

According to one of conventional techniques (hereinafter referred to as first conventional technique), an optical disk device such as a laser disk reproducer or a DVD-RAM recorder/reproducer includes a tilt-compensating device. The tilt-compensating device includes a unit for tilting a whole of a head carriage holding an optical pickup toward a radial direction of the medium according to amount of the tilt. And the tilt-compensating device compensates an amount of the tilt in lower band than a rotational frequency of its medium while the head carriage is moving toward the radial direction or after the head carriage has moved. Consequently, the tilt-compensating device can compensate an amount of the tilt depending on a position of the head toward the radial direction.

(2) Second Conventional Technique

Compensation of radial direction tilt (mentioned in (1)), however, is insufficient for a medium with high recording density. Compensation of tilt toward tangential direction of its medium is further required. A tangential direction tilt is compensated in another conventional technique shown in Japanese unexamined patent publication number H5-6555, namely 6555/1993 (hereinafter referred to as second conventional technique). According to the second conventional technique, only positions of an object lens and a compound prism are adjusted in order to keep an optical axis of the object lens perpendicular to a surface of a medium.

In the first conventional technique, the whole of the head carriage is adjusted to compensate a tilt. On the other hand, in the second conventional technique, only the object lens, prism, mirror and these supporting member are adjusted. Namely, the number of movable members for compensating tilt in the second conventional technique is smaller than that in the first conventional technique. Therefore, the second conventional technique requires less power to compensate tilt than the first conventional technique does. Furthermore, the second conventional technique can move the movable members faster than the first conventional technique can and according to this, compensation of the second conventional technique can compensate an amount of a tilt synchronously with rotation of the medium.

According to the second conventional technique, however, to tilt the object lens may cause disturbance to focusing and tracking servos of the object lens because of dimensional errors of a driving device for adjusting the object lens, or dimensional requirement of the object lens to the driving device.

(3) Third Conventional Technique

In order to avoid the above-mentioned problem of the second conventional technique, Japanese unexamined patent publication number H10-97727, namely 97727/1998, shows the following technique (hereinafter referred to as third conventional technique). According to the third conventional technique, when a tilt error signal, which a sensor outputs according to an amount of a measured tilt, shows a smaller amount than a predetermined amount, a coil for tilting starts tilting the object lens toward surface of the medium.

In a focus servo operation, the object lens is moved toward a focusing direction, which is perpendicular to the disk, when the tile error signal goes down and becomes stable. In a tracking servo operation, the object lens is moved toward a tracking direction, which is radial direction of the disk. In a tilt servo operation, the object lens is tilted toward the surface of the medium to reduce an amount of the tilt. According to the third conventional technique, the tilt servo operation does not affect the focusing and tracking servo operations.

Furthermore, according to the third conventional technique, a gain of the tilt servo is variable. After starting the tilt servo, when the tilt error signal either shows larger than a predetermined amount, or lasts within a predetermined time period, the gain is raised up during the predetermined time period. Therefore, the tilt servo operation can be done when the tilt error signal goes down and becomes stable, without affecting the focus and tracking servo operations.

The third conventional technique, however, has the following problems.

First, depending on condition of the medium, a driving current for tilting may be too high or too low and as a result, the tilt servo operation may be unstable.

Second, the gain is variable: when the tilt error signal stands for a large amount of the tilt, the gain is decreased to slow the tilt servo operation down; when the tilt error signal stands for a small amount of the tilt, the gain is increased to hasten the tilt servo operation. As a result, when an amount of the tile undesirably becomes large, an amount of tilt compensation may be too large even if the gain is adjusted.

And finally, the servo system shown in Japanese unexamined patent publication (JP-A) number H10-97727 compensates phase and furthermore, compensates signals about first resonance frequency of the tilt mechanism (hereinafter referred to as first tilt resonance frequency).

### SUMMARY OF THE INVENTION

It is the first object of the present invention to provide a servo technique for stably controlling an angle between an optical axis of the object lens and a surface of the disk, even if the angle is far from an optimum angle.

It is the second object of the present invention to provide a servo system without interference of tilt servo with track and focus servo, and consequently to provide a servo system available for reading/writing high-density disk with high reliability

Herein, brief description is made about compressibility of a tracking servo. A tracking servo for an optical disk generally serves to compress a tracking error of a focus because of decentering, etc and consequently to restrict a positioning error between a target track position and a focusing position of a laser beam within a predetermined range. Compressibility of track servo is a ratio between tracking errors before and after activating servo and is expressed as the following expression.

C=20log₁₀(E₀/E₁)[dB]

C: compressibility of tracking servo

E0: track error before tracking servo operation

E1: track error after tracking servo operation

If an absolute value of the compressibility is larger, then the track error after track servo is smaller.

According to this invention, a device for outputting a driving current to an actuator for adjusting amount of tilt between a surface of a medium of an optical disk device and an object lens of the optical disk device is provided. This device includes a band-elimination filter for stopping signals in a band including the first resonance frequency of the actuator.

Instead of the band-elimination filter, this device may include a low-band-amplifying filter for amplifying signals in a band less than a rotational frequency of the disk.

The device may include both the band-elimination filter and the low-band-amplifying filter.

In addition to these filters, the device may further include a current-limit filter for restricting driving current of the actuator.

Furthermore, the present invention provides an optical disk device including the device above.

### BRIEF DESCRIPTION OF THE DRAWING

FIG. 1 shows a block diagram of a main section of an optical disk device according to an embodiment of the present invention;

FIG. 2 shows an arrangement of beam spots on a disk of an optical system capable of detecting an amount of a tilt between an optical axis and a surface of the disk;

FIG. 3 shows arrangement of photo-detectors of an optical system capable of detecting an amount of a tilt between an optical axis and a surface of the disk;

FIG. 4 shows a perspective view of the optical disk device;

FIG. 5 shows a top view of the optical disk device 100;

FIG. 6 shows a block diagram of a focus servo system of the optical disk device 100;

FIG. 7 shows a block diagram of a track servo system of the optical disk device 100;

FIG. 8 shows a block diagram of a tilt servo system of the optical disk device 100;

FIGS. 9A, 9B and 9C show illustrations for describing an adjustment of the tilt, FIGS. 10A and 10B show graphs for describing frequency characteristics of a tilt actuator of a tilt servo system;

FIGS. 11A and 11B show graphs for describing closed loop frequency characteristics of a tilt servo system with a tilt controller of the present invention; and

FIG. 12 shows a block diagram of a tilt servo system 400.

### DESCRIPTION OF THE PREFERRED EMBODIMENTS

The present invention is applicable to an optical disk device that includes focus, track and tilt servo systems. The focus servo system is for controlling a focus of an object lens on a surface of a disk. The track servo system makes the object lens follow a data track on the disk. The tilt servo system includes a unit for detecting two tilt angles one of which is representative of an angle between the optical axis of the object lens and a radial direction of the disk, and the other of which is representative of an angle between the optical axis and a tangential direction of the disk. The tilt servo system further includes a mechanism for optimizing the tilts.

According to the present invention, the optical disk device further includes two filters that are serially connected with each other. One of the filters is for stopping signals in a band including first resonance frequency of a tilting actuator. The other one of the filters is for amplifying signals in a band lower than the rotational frequency of the disk.

Furthermore, according to the present invention, the optical disk device further includes a unit for restricting current for driving a tilting actuator if an amount of a tilt error is larger than a predetermined amount. The predetermined amount is determined in consideration of interference of tilt servo with track and focus servo operations.

Generally, if some tilts are detected between a disk and an object lens in an optical disk device, quality of signals becomes worse and consequently the disk is more incorrectly read/written. In particular, this tendency remarkably appears when recording density of an optical disk becomes high. Roughly speaking, two solutions may be applicable to this problem. The one is to reduce an amount of tilt. The other is to cancel degradation of signals. The present invention relates to the former one.

The servo system includes a mechanism for tilting the object lens and a sensor for detecting a relative angle between the disk and the object lens, and controls the tilt so as to make the relative angle closer to zero.

According to general tilting mechanisms, when the object lens is tilted, the object lens also receives a force toward the tracking direction. Namely, the tilting movement interferes with the tracking movement.

The optical disk device according to this invention may have tilting mechanisms that mechanically prevent occurrence of the interference. These mechanisms, however, cause oscillation to occur with a high-order oscillation mode because of their structural weakness, and a decline of magnetic force generated by their coils because the number of turns of the coils is reduced. Therefore, these mechanisms are unsuitable for reading/writing a high-density disk.

The present invention restrains the interference from affecting substantial movement of the object lens and is applicable even to the general tilting mechanism. Therefore, according to the present invention, both tolerance and a mechanism suitable for a high density disk can be accomplished.

1. First Embodiment

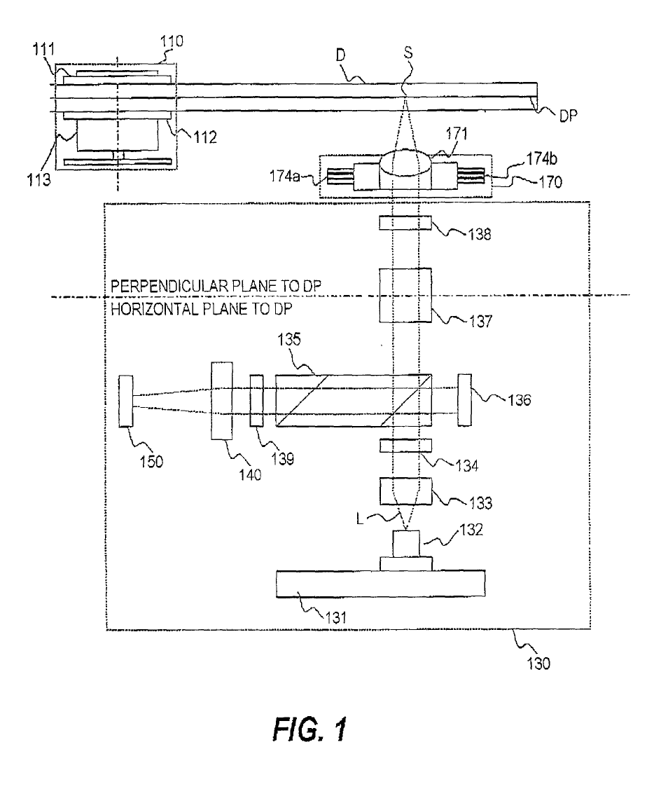

Description will be made about an optical disk device 100, which is first embodiment of the present invention. As shown in FIG. 1, the optical disk device includes a disk D, a disk rotating section 110, an optical system 130 and an actuator section 170.

(1) Disk-rotating Section 110

The disk rotating section 110 includes a chuck 111, a turntable 112, and a spindle motor 113. The disk D is put between the chuck 111 and the turntable 113 and is removable from the disk rotating section 110. The spindle motor 113 rotates the disk D, the chuck 111 and the turntable 112 as one body.

(2) Optical System 130

The optical system 130 guides a laser beam L and detects errors toward the following three directions: focus, track and tilt. For example, an optical system shown in Japanese Patent Application No. H 11-355385 (355385/1999) is applicable to the optical system 130.

The optical system 130 includes a high-frequency module 131, a laser diode 132, a collimator lens 133, a diffraction grating 134, a compound prism 135, a photo detector 136, a mirror 137, a quarter wavelength plate 138, a hologram device 139, a lens 140 and a photo detector 150.

The laser diode 132 is powered by the high-frequency module 131 to generate the laser beam L. The laser beam L is collimated by the collimator lens 133 and then conducted through the diffraction grating 134 and the compound prism 135. The compound prism 135 conducts a part of the laser beam L to the photo detector 136 and the rest of the laser beam L to the object lens 171. The photo detector 136 detects the part of the laser beam L in order to monitor output from the laser diode 132.

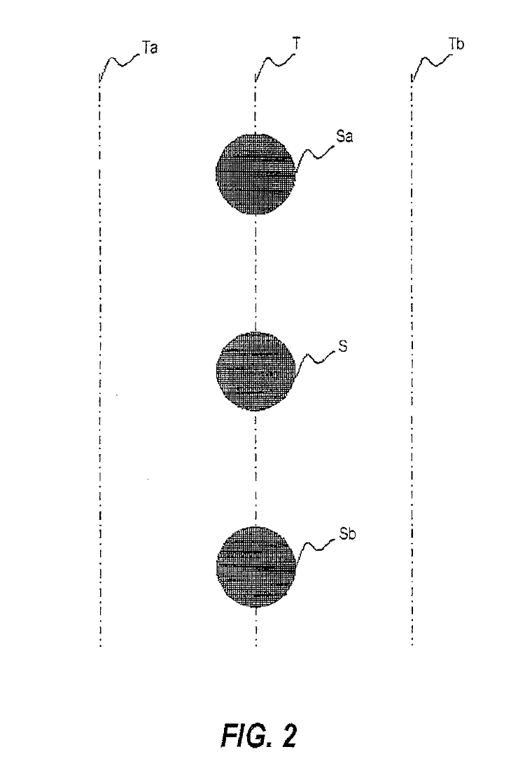

The rest of the laser beam L turns from a plane horizontal to a surface of the disk D (DP) to another plane perpendicular to the surface DP at the mirror 137 and is conducted into the object lens 171 through the quarter wavelength plate 138. The object lens 171 converges the laser beam L at a spot on the surface DP. As shown in FIG. 2, three spots are arranged on the surface DP. One of the spots is a main beam spot arranged on a targeting line T for reading/writing. The other two spots Sa and Sb are sub-beam spots.

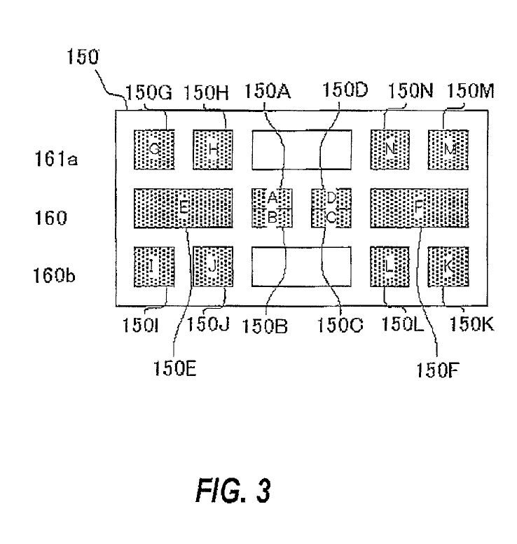

Reflections from these spots travel through the quarter wavelength plate 138 and the mirror 137 to the compound prism 135. The reflections turn toward the hologram device 139 at the compound prism 135. Next, the reflections are converged by the lens 140 on the photo detector 150 which includes detecting units 150A-N as shown in FIG. 3. Detecting units 150G, 150H, 150N and 150M, which are arranged on the top row of the photo detector 150 in FIG. 3, receive the reflection 161a, which results from the sub-beam spot Sa. Similarly, detecting units 150E, 150A, 150B, 150C, 150D and 150F arranged on the middle row of the photo detector 150 in FIG. 3 receive the reflection 160 from the main beam spot S. Detecting units 150I, 150J, 150L and 150K arranged on the bottom row of the photo detector 150 in FIG. 3 receive the reflection 160b from the sub-beam spot Sb. The detecting units 150A-N of the photo detector 150 serve to generate signals for track, focus and tilt servo operations.

(3) Actuator 170

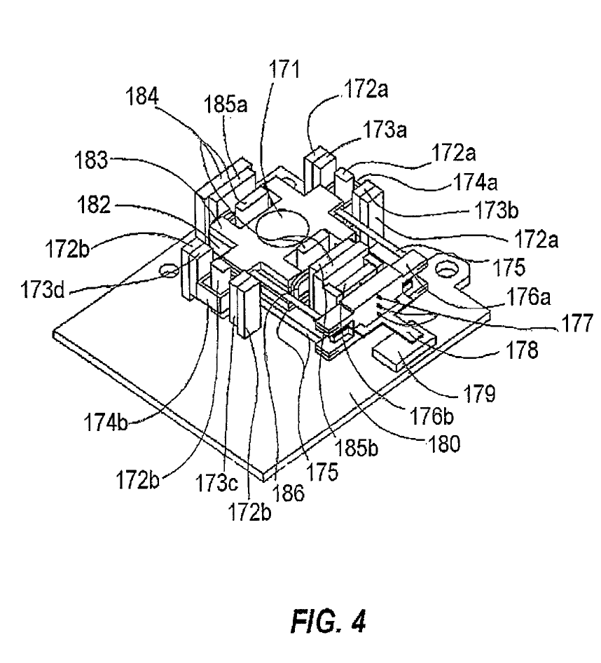

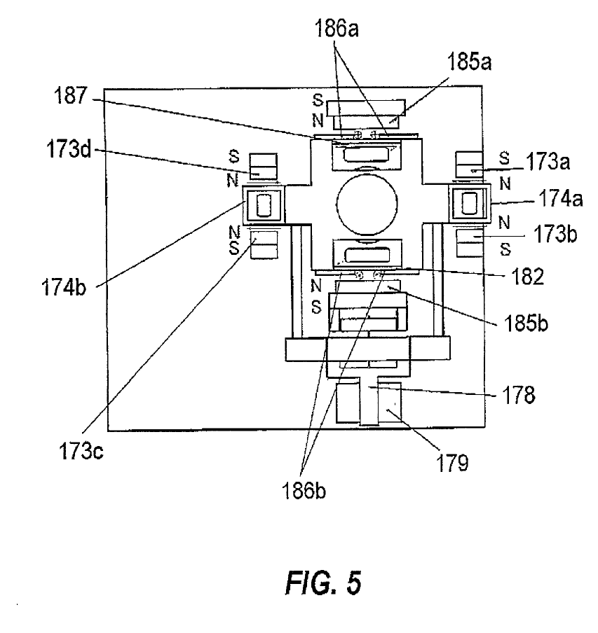

The actuator 170 is a mechanism for actuating the object lens 171 toward the surface DP. The laser beam L is converged on the surface DP in order to read/write data. The following description is made about the actuator 170 actuating the object lens, with reference to FIGS. 4 and 5.

According to Fleming's left-hand rule, a driving force toward a focusing direction is generated by a current flowing through a focusing coil 182 and by a magnetic field of a closed magnetic circuit including magnets 185a, 185b and a main yoke 184. The driving force (hereinafter referred to as focusing force) drives an object lens 171 held on a lens holder 183 against tension of a blade spring 175.

On the other hand, a current flows through a tracking coil 186a and another current reverse to the current through the tracking coil 186a flows through a tracking coil 186b. Magnets 185a, 185b and the main yoke 184 form the closed magnetic circuit that generates a magnetic field. According to Fleming's left-hand rule, these currents and magnetic field generate a driving force toward a tracking direction. This driving force (hereinafter referred to as tracking force) drives a track holder 176a against tension of a hinge spring 177.

One end of the hinge spring 177 is connected with the track holder 176a and the other end of the hinge spring 177 is connected with a track holder 176b. The track holder 176a is connected with one end of the blade spring 175. The other end of the blade spring 175 is connected with the lens holder 183, which holds the object lens 171. Therefore, the tracking force drives the object lens toward the tracking direction.

A sensor plate 178 is fixed on the track holder 176a. A sensor 179 is opposite to the sensor plate 178. When the object lens 171 is driven toward the tracking direction, the sensor plate 178 moves toward the tracking direction, and the sensor 179 detects the movement of the sensor plate 178. Therefore, the sensor 179 detects a position of the object lens 171 toward the tracking direction.

Further, magnets 173a, 173b and a side yoke 172a are placed on the right side of FIG. 4 and form a closed magnetic circuit. Magnets 173c, 173d and a side yoke 172b are shown on the left side of FIG. 4 and form another closed magnetic circuit. When currents opposite to each other on FIG. 4 are caused to flow through coils 174a and 174b, according to Fleming's left-hand rule, two driving forces opposite to each other are generated from the currents and magnetic field caused by the magnetic circuits. These driving forces (hereinafter collectively referred to as a tilting force) drive the lens holder 183 against the tension of the blade spring 175, and therefore, the object lens 183 fixed on the lens holder 183 is driven toward the radial direction.

The optical disk device 100 includes a focus servo system, a track servo system and a tilt servo system.

(4) Focus Servo System

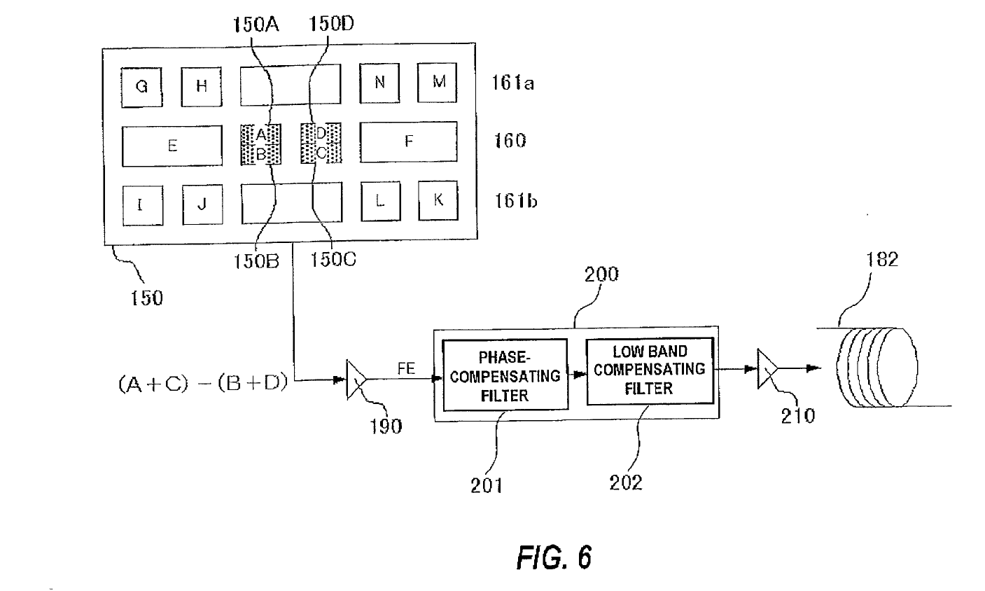

The focus servo system will be described with reference to FIG. 6. The focus servo system compensates a focus error signal FE by a servo filter to output a driving current to the focusing coil 182.

The focus servo system includes detecting units 150A, 150B, 150C, 150D, a signal composer/amplifier 190, a focus controller 200, a power amplifier 210 and the focusing coil 182. The focus controller 200 includes a phase-compensating filter 201 and a low band compensating filter 202.

Servo operation of the focus servo system is described below. First, the photo detector 150 receives reflection from the surface DP and the detecting units 150A, 150B, 150C and 150D generate signals A, B, C and D. According to these signals, the focus error signal FE (A+B)−(C+D) is generated and input to the focus controller 200. The focus controller 200 compensates the focus error signal FE to output to the focusing coil 187 the driving current corresponding to amount of the focus error signal FE.

When a condition for activating the focus servo system is not satisfied, the focus controller 200 outputs a constant current to the focusing coil 187. When the condition is satisfied, the focus controller 200 controls to make focusing operation of the object lens 171 stable. The condition is established with reference to both the focus error signal FE and a focus sum signal (A+B+C+D).

(5) Track Servo System

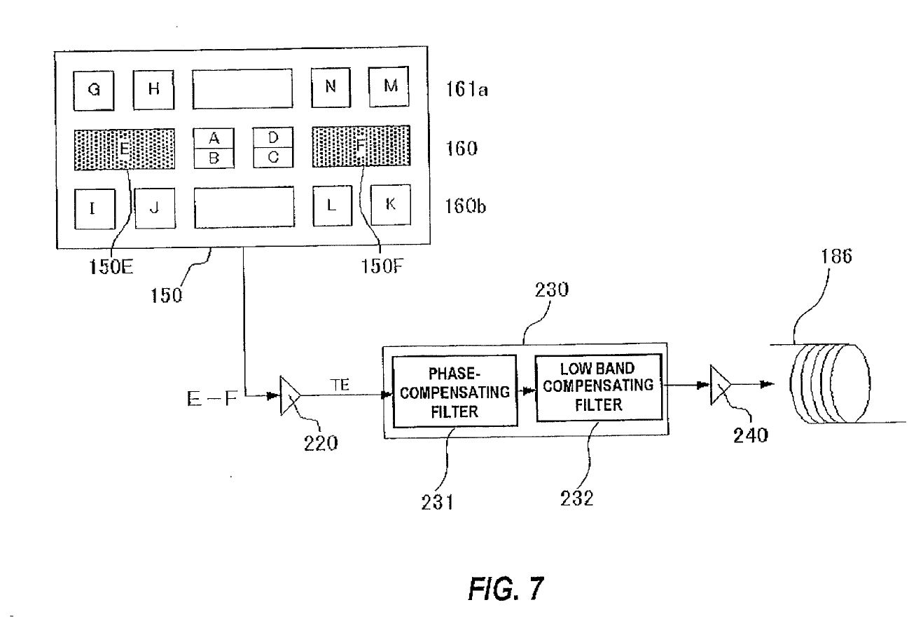

The track servo system will be described below with reference to FIG. 7. The track servo system compensates a track error signal TE by a servo filter to output a driving signal to the tracking coil 186.

The track servo system includes detecting units 150E, 150F, a signal composer/amplifier 220, a track controller 230, a power amplifier 240 and a tracking coil 186. The track controller 230 includes a phase-compensating filter 231 and a low band compensating filter 232.

Servo operation of the track servo system is described below. First, the photo detector 150 receives reflection from the surface DP. The detecting units 150E and 150F generate signals E and F to compose a track error signal TE (E−F). The track controller 230 compensates the track error signal TE in order to output to the tracking coil 186 a driving current corresponding to amount of the track error signal TE.

When a frequency of tracking is lower than a predetermined frequency and the track error signal is lower than a predetermined value, the track controller 230 controls the object lens 171 to be stable.

(6) Tilt Servo System 300

The tilt servo system 300 detects a relative tilt between the disk D and the object lens 171 as amount of a tilt. Next, the tilt servo system 300 compensates the amount of the tilt. After that, the tilt servo system 300 controls the object lens 171 to decrease the relative tilt.

When the object lens 171 is tilted, a spot of the laser beam L moves toward the tracking direction on the surface D, Namely, moving the object lens 171 toward the tilting direction inevitably brings about interference of a force toward the tracking direction. This is because principal points of the object lens 171 are not coincident with a center of the tilt rotation movement.

There are conventional servomechanisms, which mechanically prevent occurrence of the interference. However, the conventional servomechanisms tend to have weak structure and to cause a high-frequency oscillation mode. Furthermore, in the conventional servomechanisms, it is so hard to increase number of turns of a coil that the force generated by the coil tends to be weak, Therefore, the conventional servomechanisms are unsuitable for high-density packaging.

On the other hand, according to the present invention, the tilt controller 260 is improved in structure to prevent occurrence of the interference of the tilt servo operation with the track servo operation.

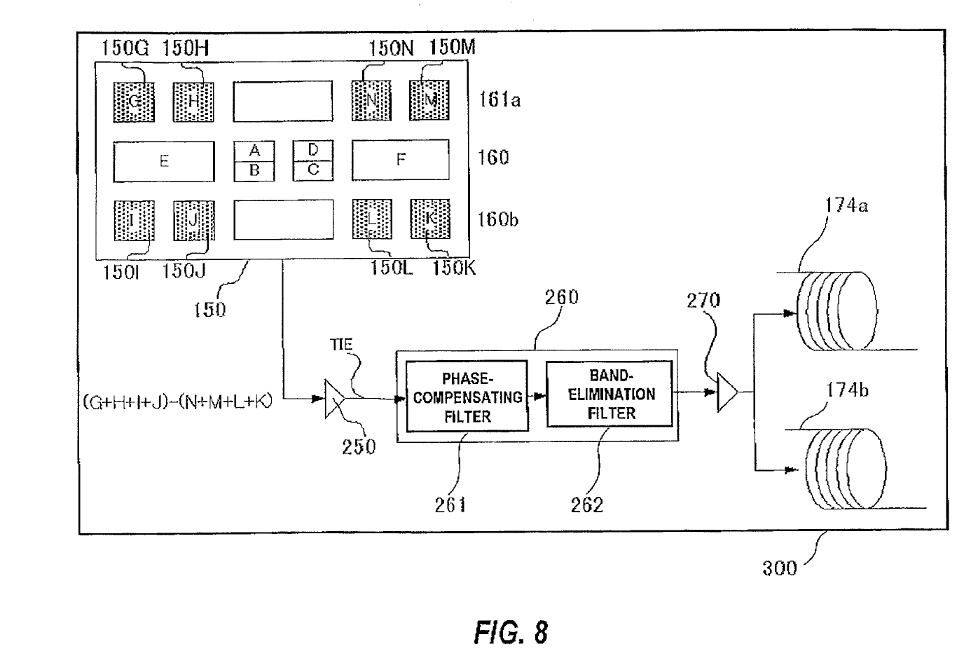

Servo operation of the tilt servo system 300 is described below with reference to FIG. 8. The tilt servo system 300, first, detects the tilt error signal, next, compensates the signal by servo filters, and finally, outputs a tilt driving current to tilting coils 174a and 174b.

With reference to the detecting units 150G, 150H, 150I, 150J, 150K, 150L, 150M and 150N, a signal composer/amplifier 220 composes a tilt error signal TE (G+H+I+J)−(N+M+K+L). The tilt error signal is compensated by the tilt controller 260 and then amplified by the power amplifier 270 in order to drive the tilting coils 174a and 174b.

The tilt controller 260 includes a low band amplifying filter 261 and a band-elimination filter or a band rejection filter 262.

The low band amplifying filter 261 amplifies a signal whose frequency is less than the rotational frequency of the disk D in order to increase the gain of the tilt servo.

When the tilt servo gain is high, the tilt servo operation easily interferes with the track servo operation. However, in a domain under the rotational frequency, compressibility of the track servo is sufficiently high. Therefore, the track servo operation is hardly affected even if the tilt servo operation interferes with the track servo operation. It is noted that, even at the rotational frequency, if the tilt servo band increases, then the tilt servo gain in a domain over the rotational frequency increases, and as a result, the interference occurs in the domain under the rotational frequency. In order to prevent the occurrence of the interference, the tilt servo gain should be set within a restriction where the track servo operation is not affected in a high frequency domain.

Generally, a tilt actuator has a first resonance frequency higher than those of focus and track actuators, because of structure of the tilt actuator. Further, the compressibility of the track servo is lower in a band about the first tilt resonance frequency, than in a band about the rotational frequency.

A filter that rejects signals about the first tilt resonance frequency is available for decreasing a peak value at the first resonance frequency of the tilt actuator. Under the rotational frequency of the disk, the compressibility of the tilt servo is enough high, and consequently, the track servo operation is less affected even if the tilt servo gain is high.

The band-elimination filter 262 prevents signals near to the first tilt resonance frequency from passing. As a result, the band-elimination filter 262 is available for decreasing a resonance peak, which specifies a peak of resonance caused by the tilt actuator according to internally/externally mechanical vibration, in order to prevent the tilt from further moving. A lowest frequency, at which a peak resonance occurs when mechanical characteristics of the tilt actuator are measured in a frequency domain, is referred to as a first resonance frequency, namely, a first tilt resonance frequency.

Because of the above-mentioned structure, the tilt actuator has a first resonance frequency higher than focus and track servo actuators do. The compressibility of the track servo in a band near to the first tilt resonance frequency is not higher than that in a band under the rotational frequency of the disk. Consequently, when the tilt servo operation is activated in the band about the first tilt resonance frequency, it is probable that the tilt servo operation interferes with the track servo operation even if the tilt servo gain is low.

As mentioned above, according to the tilt controller 260 including the low band amplifying filter 261 and band-elimination filter 262, the tilt servo operation is able to be more stable.

According to a tilt servo sequence of the tilt servo system 300, the tilt servo system 300 can detect a tilt when the track servo operation is activated. Therefore, the three servo operations are activated in the order of the focus, track and tilt.

(7) Influence of the Tilt Servo Upon the Track Servo

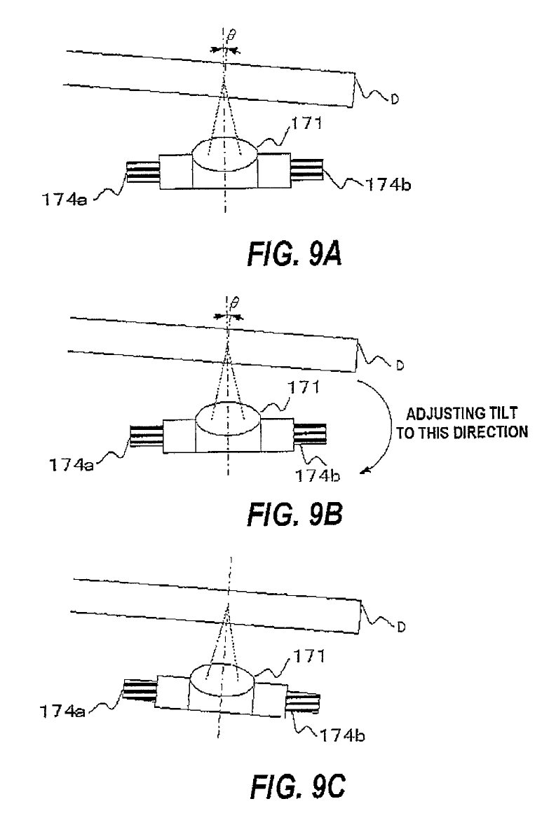

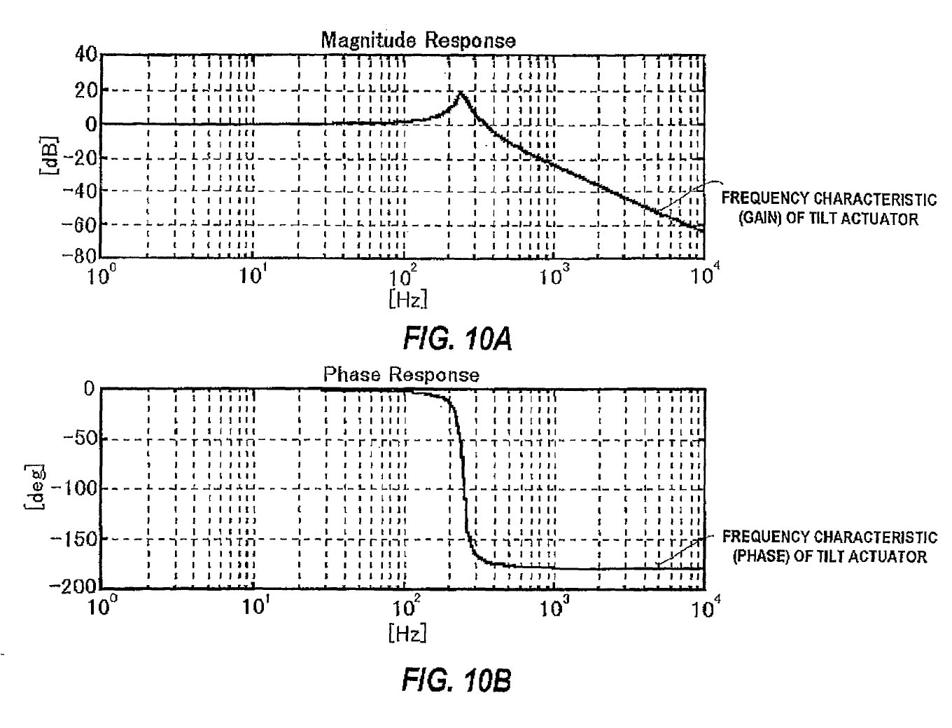

An angle between the perpendicular line to the surface DP and the optical axis of the object lens 171 is referred to as θ. FIG. 9A shows where the tilt servo is inactivated and the angle θ is large and accordingly the tilt error signal TIE is large.

When the tilt servo starts to be activated, the tilt controller 260 compensates the tilt error signal TIE by tilting the object lens 171 and as a result, reduces the angle θ as shown in FIG. 9B. Finally, as shown in FIG. 9C, the angle θ is equal to zero. Namely, the surface DP and the axis of the object lens 171 become perpendicular to each other.

FIGS. 10A and 10B are Bode diagrams that show amount of the tilt of the object lens measured by a sensor when an oscillator signal (a sine signal corresponding to a measuring frequency) is input to the tilt actuator. FIG. 10A shows the amount of the tilt as gain and FIG. 10B shows the amount as phase.

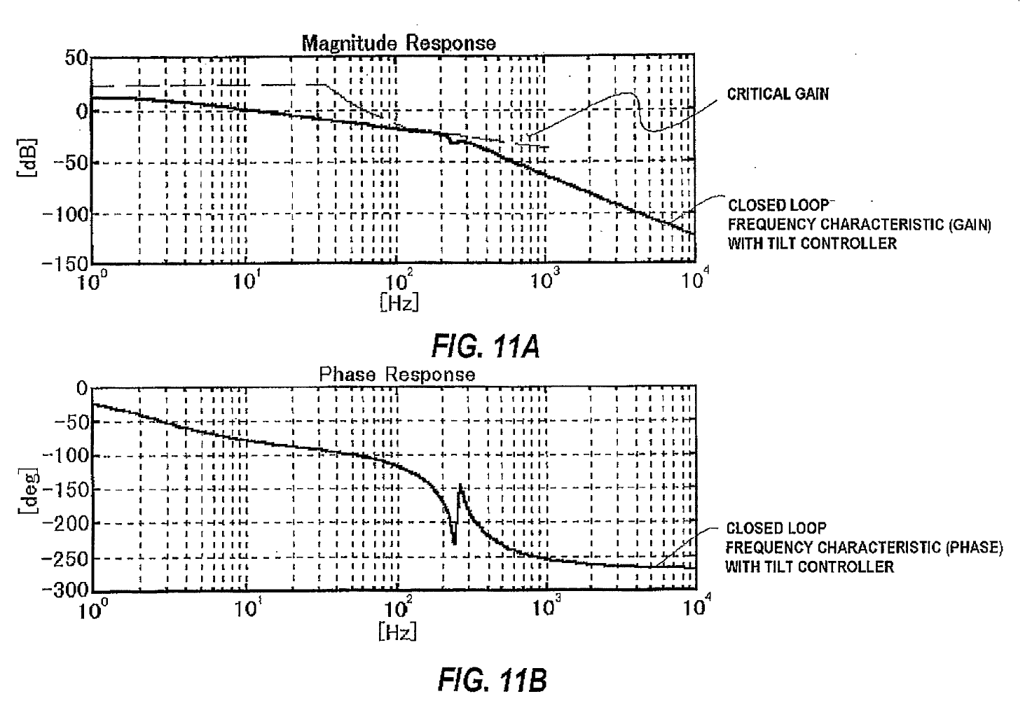

On the other hand, FIG. 11 is a Bode diagram that shows the amount of the tilt of the object lens measured by a sensor when the oscillator signal is input thorough the tilt controller to the tilt actuator. The same as FIGS. 10A and 10B, FIG. 11A shows the amount of the tilt as gain and FIG. 11B shows the amount as phase. In addition, FIG. 11A shows a critical gain curve which shows limitation where tracking error is able to be restricted within a predetermined specification (e.g. 5% of the maximum push-pull of the track error signals), even if the tilt servo operation interferes with the track servo operation.

The gain-frequency characteristic curve shown in FIG. 10A has a peak when the frequency of the oscillator signal is equal to 250 Hz. On the other hand, with reference to FIG. 10B, the phase is delayed by 180 degrees at 250 Hz of the phase-frequency characteristic curve. Therefore, the first tilt resonance frequency of the tilt actuator is known as 250 Hz.

As shown in FIGS. 11A and 11B, stability of the tilt servo system 300 is apparent from the characteristic curve obtained by the tilt controller. In a frequency domain wherein the gain is more than 0 dB and the phase is less than 180 degrees, the servo system can stably reduce its error.

Generally, a servo system is more stable if the phase is more advanced over 180 degrees in a frequency wherein the gain is less than 0 dB. If the gain peak is over zero at the first tilt resonance frequency, the phase is delayed over 180 degrees and the servo system becomes unstable. In the tilt servo system 300, a sign of the tilt error signal TIE is reversed, and the reversed signal is input to the controller, namely the tilt error signal is fed back to the controller. The feedback system adds amount of the detected error as a brake to a control signal.

In the tilt servo system 300, signals compensated by the tilt controller 260 is set less than the critical gain curve when the angle θ shown in FIG. 9 is large. Therefore, the interference of the tilt servo operation with the track servo operation is inconsiderable.

2. Second Embodiment

Description will be made about second embodiment of the present invention. Compared with the first embodiment, components of the tilt controller is different. Hereinafter, a tilt servo system of the second embodiment is referred to as a tilt servo system 400, and a tilt controller of the tilt servo system 400 is referred to as a tilt controller 280. The rest of the elements composing the second embodiment are the same as those of the first embodiment. Therefore, description about the rest elements will be omitted.

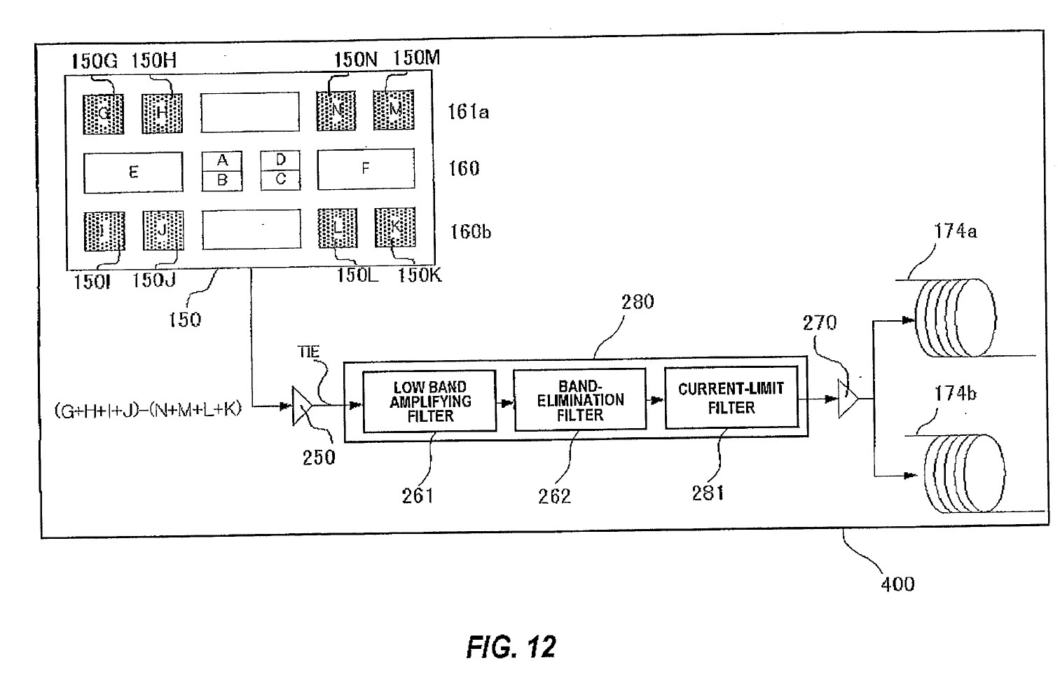

As shown in FIG. 12, the difference between the tilt controllers 260 and 280 is whether a current-limit filter 281 is included or not. The current-limit filter 281 restricts currents added to tilting coils 174a and 174b.

If the gain is higher at the rotational frequency, the interference with the track servo becomes larger. However, the current-limit filter 281 prevents the track servo operation from affecting the tilt servo operation. If the gain is increased, the currents through the tilting coils 174a and 174b are restricted. Therefore, the interference of the tilt servo operation with the track servo operation is reduced.

If the angle θ shown in FIG. 9 is large, signals input to the current-limit filter 281 become over a predetermined threshold value, and consequently, the currents are restricted. The threshold is determined according to a critical gain. A tilt driving force for generating permissible amount of track error within a servo sampling time is determined. The threshold is proportional to the tilt driving force. The current-limit filter 281 generates currents less than the threshold.

The tilt controller 280, which includes the current-limit filter 281, is available for increasing gain in a frequency domain under the rotational frequency of the disk shown in FIG. 11, and for decreasing gain in the other domain over the rotational frequency.

3. Conclusion

In an optical disk device that reads and writes a disk with converged laser light, an angle between the optical axis of the optical pickup and the disk should keep an target angle. However, dimensional errors of its mechanism or a warp of the disk easily cause an optical error between the target and current angle.

One technique for correcting the optical error is to control the object lens by not only the focus servo and the track servo but also the tilt servo, which keeps the optical axis perpendicular to the surface of the disk.

In an ordinary optical disk device, the rotational axis of the principal point of the object lens disagrees with the rotational axis of the tilting movement. Therefore, if a conventional tilt servo system compensates amount of the tilt, then the tilt servo interferes with the track servo.

According to the first embodiment of the present invention, the tilt controller includes a filter for stopping signals about the first tilt resonance frequency and a filter for amplifying signals in a band less than the rotational frequency of the disk. The tilt controller compensates tilt error signals with these filters. Consequently, the tilt servo is stably activated without affection to the focus and track servos.

According to the second embodiment of the present invention, the tilt controller further includes a filter for restricting driving current of the tilting coils. Consequently, the tilt servo is stably activated even if the current angle is far from the target angle.

As mentioned above, the present invention can prevent interference of the tilt servo with the track servo, even if the rotational axis of the principal point of the object lens disagrees with the rotational axis of the tilt movement of the object lens. Consequently, the present invention can provide the optical axis of high precision. Especially, the high precise optical axis is useful for an optical disk device for high-density disk.

While this invention has thus far been described in conjunction with a few embodiments thereof, it will be readily possible for those skilled in the art to put the this invention into various other manners. For example, the present invention is applicable not only to an optical disk device for reading an optical disk, but also an optical disk device for writing an optical disk and for both reading and writing an optical disk.

What is claimed is:

1. A device for outputting a driving current to an actuator for adjusting amount of tilt between a surface of a medium of an optical disk device and an object lens of the optical disk device, comprising a filter for stopping signals in a band including the first resonance frequency of the actuator.

2. A device for outputting a driving current to an actuator for adjusting amount of tilt between a surface of a medium of an optical disk device and an object lens of the optical disk device, comprising a filter for amplifying signals in a band less than a rotational frequency of the disk.

3. A device for outputting a driving current to an actuator for adjusting amount of tilt between a surface of a medium of an optical disk device and an object lens of the optical disk device, comprising:
a first filter for stopping signals in a band including the first resonance frequency of the actuator; and
a second filter for amplifying signals in a band less than a rotational frequency of the disk.

4. The device claimed in claim 1, further comprising a filter for restricting driving current of the actuator.

5. The device claimed in claim 2, further comprising a filter for restricting driving current of the actuator.

6. The device claimed in claim 3, further comprising a filter for restricting driving current of the actuator.

7. An optical disk device comprising the device as claimed in claim 1.

8. An optical disk device comprising the device as claimed in claim 2.

9. An optical disk device comprising the device as claimed in claim 3.
